(19) United States
(12) Patent Application Publication
(10) Pub. No.: US 2002/0130771 A1
(43) Pub. Date: Sep. 19, 2002

(54) Vehicle wheel monitoring system

(76) Inventors: Corwin K. Osborne, Scottsdale, AZ (US); Alfred A. Wiest, Peoria, AZ (US)

Correspondence Address: Woodbridge & Associates, P.C., P.O. Box 592, Princeton, NJ, 08542, US

(21) Appl. No.: 09/931,958

(22) Filed: Aug. 17, 2001

Related U.S. Application Data
(60) Provisional application No. 60/225,980, filed on Aug. 17, 2000.

(51) Int. Cl. B60Q 1/00

(52) U.S. Cl. 340/438; 340/441

(57) ABSTRACT

A system for remotely sensing the temperature and pressure in vehicle tires whether moving or stationary. The tire pressure and temperature data along with a unique ID number are transmitted from a sensor in the tire to a computer display in the cab. A portable cab display receives the data and assigns a unique wheel location for each sensor. The cab display compensates the pressure data for local barometric pressure and actual tire temperature and displays the compensated data to the driver. Alarms are included to alert the driver of off specification conditions. The cab display may be removed from the cab for local use.

### CROSS REFERENCE TO RELATED APPLICATIONS

This application claims the priority of U.S. Provisional Application Serial No. 60/225,980 entitled “WHEEL TEMPERATURE AND PRESURE SENSING MONITORING SYSTEM” filed on Aug. 17, 2000, the entire contents and substance of which are hereby incorporated in total by reference.

### BACKGROUND OF THE INVENTON

1. Field of the Invention

The present invention relates to a vehicle wheel monitoring system and method, and particularly to a system and method for collecting data relating to vehicular operation, processing such data, and providing the processed data to the vehicular operator, owner, and/or to maintenance facility personnel.

2. Description of Related Art

Approximately 70 percent of all U.S. commerce is shipped through commercial trucking companies. Costs for vehicle drivers, fuel, and tires are the top three operating expenses for trucking companies. How companies manage all of these costs is critical to their success. Maintaining proper tire pressure and wheel assembly operating temperatures can make a significant difference in lowering operating costs while improving overall road safety.

Tire pressures that are either too low or too high reduce tire life. Under-inflated tires increase rolling resistance and, as a result, increase fuel consumption and shorten tread life. At the end of tread life, tire casings have monetary value because they may be recapped. The residual value of a tire casing can be adversely affected by operating it in an under-inflated and/or over-loaded condition.

There is another equally compelling factor for more than 20 million heavy-duty trucks operating on the road today. There is considerable concern over tire safety and the terrible accidents that can result from blowouts. Significantly under inflated tires cannot safely carry the same weight of properly inflated tires and hence may pose a safety hazard. An under-inflated tire can lead to an over-loaded and over-heated tire during its operation making it more prone to failure. Blowouts rarely occur without there first being an overheating of the tire. Most blowouts can be prevented by proper tire inflation, which can be maintained if a driver is alerted to abnormal operating pressures and temperatures. Some major tire manufacturers have delivered information to the National Highway Transportation Safety Administration (NHTSA) indicating that significantly under-inflated tires also degrade a vehicle's cornering abilities and increase stopping distance on wet surfaces.

There has been an increase in public awareness of the need for tire pressure monitors as a result of recent tire failure problems experienced by some automobile and tire manufacturers. The U.S. Government mandated on Nov. 1, 2000 by the signing of the Transportation Recall Enhancement, Accountability, and Documentation (TREAD) Act, that the National Highway Safety Administration (NHSTA) enter into a rule making process that is directed toward the incorporation of tire pressure monitoring systems into new vehicles with gross weights of 10,000 pounds or less. Some four-wheel automobile manufacturers are announcing that they are working to introduce this capability into their sport utility vehicles by 2005. This situation has been a catalyst for technology developers looking for a wide range of solutions to meet market needs for increased safety of all on-road and off-road vehicle operations, and offer the solution in a cost-effective manner.

The Federal Motor Carrier Safety Administration (FMCSA) has initiated a program which addresses tire maintenance issues on heavy-duty vehicles. The FMCSA plans to conduct a comprehensive study, including possible fleet evaluations of different systems, of all the issues related to improvement of heavy-duty vehicle tire maintenance. NHSTA plans to coordinate with the FMSCA the results of this study and to examine the desirability of imposing a tire pressure monitoring system standard for heavy-duty vehicles.

In attempts to meet this large and recognized need, several technology developers have tried to develop various tire monitoring systems. Examples include “chip-in-tire” systems and electronic pressure gauges. Most current “chip-in-tire” technologies only makes measurements while the vehicle is stationary. Many of the electronic pressure gauge systems require the vehicle to either be moving or stationary. Those systems that require the vehicle to be moving usually employ a roll detection switch to enable its operation. These systems are unable to detect leaking wheel assemblies when the vehicle is parked. Almost all of the currently existing systems do not take into account the effect of operating temperature and barometric pressure changes with respect to the accuracy of their measurements. Other examples include mechanical thumping devices, mechanical pressure gauges, air transfer systems and central tire inflation systems that do not provide accurate and timely caution and warning information to the vehicle operator in the cab while the vehicle is moving.

Tire pressure monitoring systems to date have focused mainly on sensor technology development influenced mainly by the four-wheel automotive light vehicle market that utilizes simple go/no-go indicators.

There are a number of pressure measuring solutions implemented in automobiles and light trucks. The technical problems associated with wheel identification and operating location assignment in a vehicle are much more easily addressed for a four-wheel vehicle as compared to more complex heavy-duty vehicles. Commercial heavy-duty trucks are typically operated in configurations of two to nine axles employing anywhere from six to thirty-four wheels.

The pressurized wheel assemblies in a large multi-axle, multi-wheel truck can be randomly installed anywhere on the vehicle. Consequently, a method and apparatus must be employed to properly identify the sensor arrays operating at their randomly installed locations in the vehicle. No cost effective or operationally effective method or apparatus has been developed to address the sensor identification and vehicle installation location problem for heavy-duty trucks.

Some technology developers have proposed factory preset installation or custom build-to-order schemes that are simply not practical for typical trucking industry applications. These systems require that specific sensors be installed in specific pre-determined locations on the vehicles. Custom build-to-order systems are of limited value and will not generate a broad market appeal since vehicle configurations used in the trucking business can vary widely and dynamically in the operating environment. Current commercial trucking industry repair and maintenance depot practices may call for several hundred rims, tires, and/or pressurized wheel assemblies to be staged for installation on the next truck into the depot. Requiring certain sensor arrays to be installed only at certain wheel locations in a heavy-duty truck makes the management of such a system a logistics nightmare for the depot personnel.

Brown, in U.S. Pat. No. 4,978,941 discloses a tire monitoring system in which a receiver is located near each tandem axle on a tractor-trailer for detecting low power transmissions from transmitters in each wheel hub. Each wheel is not uniquely identified but the choice is narrowed by the proximity of a receiver to the suspect tires.

Bowler et. al., in U.S. Pat. No. 5,231,872, also discloses a tire monitoring system in which tire temperature and tire pressure are measured. In the Bowler et. al. system, all tires on a trailer have the same identification number that obliges the driver to physically inspect a group of tires to determine the problem, if any.

There are known tire monitoring systems for tractor-trailer systems that use dedicated electronics to identify each tire. For example, Williams, in U.S. Pat. No. 5,109,213, discloses a system in which a small transmitter package is attached to the outside of a wheel assembly where it is prone to damage in a severe operating environment. A mechanical dual in-line (DIP) package switch in each package must be physically set by the operator to identify each wheel uniquely. Locating such a mechanically delicate switch externally on the wheel exposes it to a harsh operating environment on the outside of the wheel. Also, access by the operator to the DIP switches is difficult once the wheels are installed on a vehicle, especially at an inside dual wheel location. This is significant, since heavy duty commercial vehicles are routinely reconfigured into various combinations of tractors, semi-trailers, full trailers, converter dollies, and straight trucks

Coulthard, in U.S. Pat. No. 5,825,826, discloses a method and apparatus for the wheel identification and assignment function that requires the user to maintain and track manufacturing paperwork corresponding to the installed wheel modules. If the user ever misplaces or loses the paperwork and the wheel installation is changed, then the wheel assembly must be removed from the vehicle and the tire demounted from the rim in order to be able to identify the unique serial number of the installed electronics module.

Other technology developers have proposed the utilization of bar code readers for the randomly installed wheel assemblies. In this approach, bar coded labels are affixed to the sensor arrays during manufacture. Separate labels with matching bar codes corresponding to the installed sensors internal to the tire are externally attached on the rim of the corresponding wheel assembly. However, the wheel module labeling method has proven to be impractical due to the following problems:

Label durability and readability in the severe heavy-duty truck operating environment.

Errors are created when the internal sensor array bar code labels and the external labels are not maintained as identically paired labels all the way through the product manufacturing to vehicle installation process.

Operators are unable to view the labels in a practical manner on the wheels once the pressurized wheel assemblies are installed on the vehicle (especially at dirty inside dual wheel locations).

Difficulties are encountered by the physical separation, misplacement, loss, and replacement of the bar coded labels during the pressurized wheel assembly and sensor array life cycle. These difficulties include:

Sensor array manufacturing and test operations.

Sensor array shipping and handling.

Internal installation of the sensors on rims during tire installation operations.

External installation of the labels on the wheel assemblies.

Completed tire and rim wheel assembly storage in maintenance and repair facilities.

Wheel assembly installation on the vehicle.

Wheel assembly operation on the truck.

Tire and rim replacement operation cycles.

Owners' objections to attaching labels to custom rims.

Several tire companies have tried molding a microchip in each tire during the manufacturing process. These chips are supposed to transmit temperature and/or pressure readings to an external monitor near the vehicle when it is stationary. The “chip-in-tire” developers have laid out plans to locate the external monitoring equipment at fuel stops, fleet operations yards, maintenance, or repair facilities. Hence, the current “chip-in-tire” technology does not allow the temperature and pressure of the wheel assemblies to be continuously monitored while the vehicle is moving on the road. Requiring the external monitoring equipment to be located at such fixed location facilities has imposed this limitation. The “chip-in-tire” approach has encountered numerous technical problems during product development and a practical marketable product is not expected for several years.

The present invention provides continuous monitoring and reporting of the operating temperature and pressure of each wheel assembly while the vehicle is moving or stationary since the monitoring equipment is integrated into the on-board system in.

Some automotive vehicle manufacturers are utilizing Anti-lock Brake System sensors in their tire pressure monitoring systems. In this approach, the rotational speed of an under-inflated tire is compared to the rotational speed of other tires in the vehicle. This type of system does not provide for the direct or accurate measurement of the operating conditions of the pressurized wheel assembly. Systems of this nature will not detect an under-inflated tire until it is 20-30 percent below its ideal inflation pressure. Also, this type of system implementation cannot detect under-inflated tires when all of the tires in the system leak at relatively equal rates. Not all trucks have Anti-lock Brake Systems. Systems implemented using the Anti-lock Brake sensor approach simply will not yield the economic and safety benefits of the present invention to the commercial trucking market.

Many of the existing automotive tire pressure monitoring systems only measure pressure in a wheel assembly. The operating temperature of the wheel assembly has a significant effect on the operating pressure inside the tire. An operating temperature increase from 72° F. to 140° F. in a wheel assembly will cause a 13 pounds per square inch (psi) gauge pressure increase in a truck tire normally operated at a cold (72° F.) inflation pressure of 100 psi. The same tire operating at 23° F., experiences a 9 psi drop in pressure. Consequently, if tire caution and warning alerts of these systems are set in a fixed manner without taking the operating temperature effect into account, then either false alerts will be generated as the wheel assembly pressure varies with varying operating temperatures or the alert limits will be set so wide that the alerts are ineffectual.

It is clear from the above discussion that a serious need exists for an effective tire management tool that will provide significant safety and economic benefits for the commercial trucking industry.

### SUMMARY OF THE INVENTION

The present invention provides a vehicle wheel monitoring system useful to commercial trucking companies as a tool to help lower operating costs and improve overall road safety.

The present invention embodies a system that automatically measures in real time the operating pressure and temperature of each wheel assembly in a vehicle, whether moving or stationary, and feeds that information via a robust wireless data communication link to a computer display unit that the driver views in the cab. The system's computer determines both unsafe and sub-optimal operating conditions and alerts the driver to take corrective action.

The system includes an electronic sensor module for each wheel of the vehicle that is mounted on the drop center of the rim inside the tire. Each of these electronic sensor modules measures tire inflation pressure and operating temperature for its wheel location. Then at specified intervals and conditions, the modules automatically transmit this data to a hand-held computer display unit located in a cradle in the vehicle cab. The system provides the operator with optimum operating tire pressure information. It informs the driver when the operating temperature or pressure breaches operator selected efficiency limits. Additionally, the computer display unit automatically informs the operator as to whether or not the wheel assembly temperatures and pressures are within normal safe operating conditions. All gauge pressure readings are compensated for operating temperature changes in the wheel assembly. The system also automatically compensates gauge pressure readings for changes in the operating altitude of the vehicle (i.e. local ambient pressure conditions effects on the gauge pressure readings).

The operator can remove the hand-held computer display unit from the cradle in the vehicle cab and utilize it as an “at the wheel” electronic tire pressure gauge. When utilized in this manner at the wheel, the system will display actual and “ideal” tire pressure information to the operator. The indicated pressures presented to the operator will automatically compensate for operating temperature changes in the wheel assembly (i.e. the operator will be presented with the “ideal” inflation pressure at the time of the actual inflation pressure measurement regardless of whether or not the wheel assembly is hot or cold).

The invention may be more fully understood by reference to the following drawings.

### BRIEF DESCRIPTION OF THE DRAWINGS

FIG. 1 is a system level block diagram of the major functional elements preferred embodiment of the present invention.

FIG. 2 is illustrates the location of two of the major components of the embodiment of FIG. 1 in a typical 18-wheel heavy-duty commercial truck.

FIG. 3 is an illustration of a diverse set of multi-axle, multi-wheel vehicles typically found in the North American commercial trucking industry.

FIG. 4 is an illustration of a diverse set of commercial trucking Longer Combination Vehicles (LCV's) that are permitted to operate only in certain states of the U.S.A.

FIGS. 5a and 5b are illustrations showing the present invention's vehicle wheel location nomenclature applied to a typical 18-wheel heavy-duty tractor/semi-trailer truck.

FIGS. 6a and 6b are illustrations of the computer display unit CDU) showing the operational interface of the vehicle wheel monitoring system.

FIGS. 7a-c illustrate typical information presented on the liquid crystal display of the CDU for an 18-wheel tractor/semi-trailer vehicle.

FIGS. 8a-d illustrate the caution and warning icons on the CDU used to alert the driver of inefficient or unsafe operating conditions in the vehicle wheel assemblies.

FIG. 9 shows the effects of operating temperature on selected ideal inflation pressures.

FIG. 10 illustrates the vehicle wheel monitoring system caution and warning system alert limits that must be compensated for operating temperature conditions in the wheel assemblies.

FIG. 11 shows the wheel temperature caution and alert limits.

FIG. 12 is a block diagram of the wheel module assembly (WMA).

FIG. 13 is an illustration of the WMA electronics packaging design.

FIGS. 14a-c are illustrations showing the installation of the WMA with a tensioning strap.

FIG. 15 is a block diagram of the CDU.

FIGS. 16a-d show examples of vehicle configuration icons that the operator may select in the Configuration Mode.

FIGS. 17a-c illustrate the 115 KHz low frequency signal radiating from the wheel probe interface antenna at the back of the CPU.

FIGS. 18a-b show the scanning pattern employed during the WMA interrogation process used in the Wheel Identification and Assignment function in the Assign Wheels Mode.

FIGS. 19a-b illustrate the CPU orientation during the scanning operation used to interrogate the WMAs in the Assign Wheels Mode.

FIGS. 20a-b are an illustration of the power cradle unit (PCU) showing the interface connectors to the CDU.

FIG. 21 is a block diagram of the PCU.

FIG. 22 is an illustration of the Power Cable Assembly (PCA) installation.

### DETAILED DESCRIPTION OF THE PREFERRED EMBODIMENT

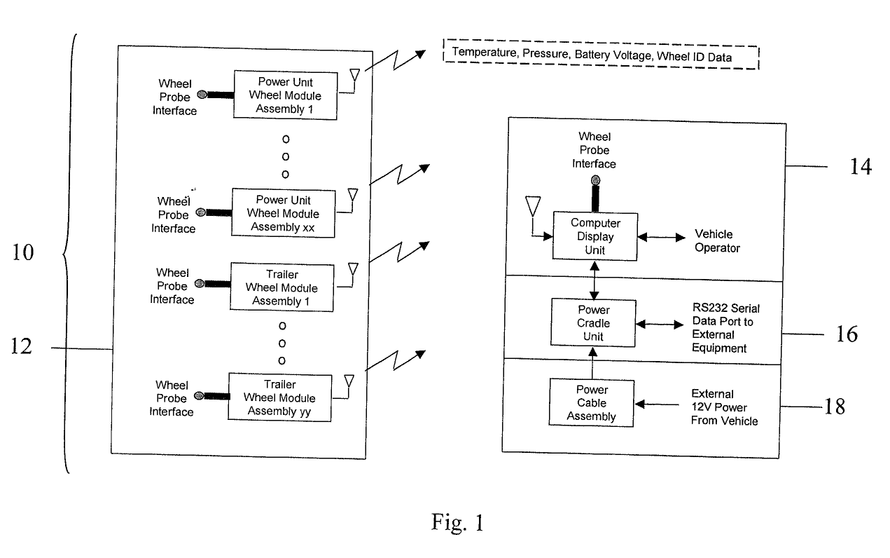

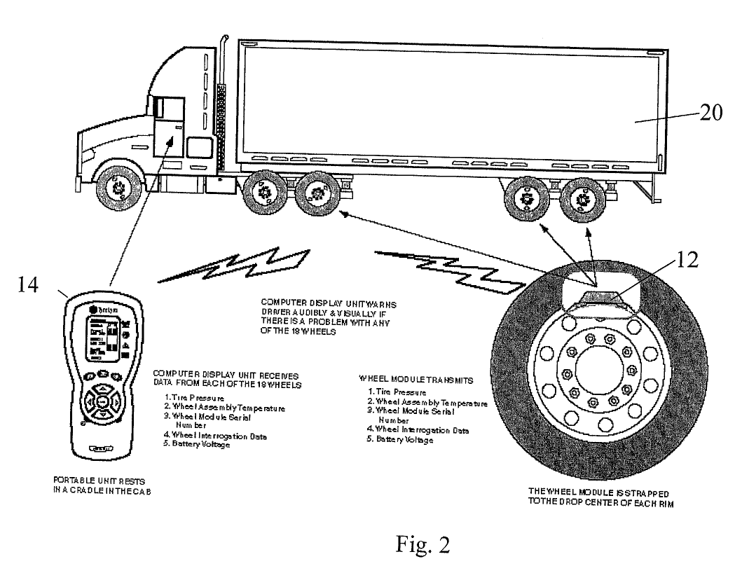

A block diagram of the preferred embodiment 10 of the present invention is shown in FIG. 1. Vehicle wheel monitoring system (VWMS) 10 includes a wheel module assembly (WMA) 12, a computer display unit (CDU)14, a power cradle unit (PCU)16 and a power cable assembly (PCA) 18. Temperature and pressure data are acquired through sensors located in each WMA 12, and are transferred via a wireless data communication link to CDU 14 mounted in a PCU 16 located in the cab of the vehicle. The locations of the WMA 12 and CDU 14 in a representative vehicle 20 are shown in FIG. 2. The measured temperature and pressure for each WMA is automatically displayed by the CDU 16 as selected by the driver.

The VWMS 10 automatically provides the operator with optimum operating tire pressure information. The system informs the driver when the temperature or pressure breaches selected efficiency limits. Additionally, the CDU 14 automatically informs the operator as to whether or not the wheel assembly temperatures and pressures are within safe operating conditions. The system automatically accounts for changes in the operating environment of the vehicle, specifically temperature and altitude.

The present invention also functions as a non-contacting “at the tire” electronic tire pressure gauge. When CDU 14 is utilized in this manner at the tire, the present invention displays actual and ideal tire pressure information to the operator. The pressures presented to the operator are automatically compensated for operating temperature changes in the wheel assembly (i.e. the operator is presented with the ideal inflation pressure at the time of the actual inflation pressure measurement regardless of whether or not the wheel assembly is hot or cold). Additionally, the system automatically compensates for changes in operating altitude (i.e. local ambient pressure conditions).

Operating temperatures in a wheel assembly are driven by the following heat sources:

Tire operating temperatures whose heating is created by such factors as mechanical flexing of the tire structure under load, rolling resistance on the road, ambient temperature conditions, and thermal radiation heat gain from exposure to the sun.

Axle bearing heat load inputs transmitted to the piloted-hub mounting interface of the wheel assembly rims.

Braking system heat load inputs to the wheel assembly rims.

Consequently, the wheel monitoring system can not only be viewed as tire temperature safety monitor, but also can be viewed as a leading indicator for axle bearing and brake system failures.

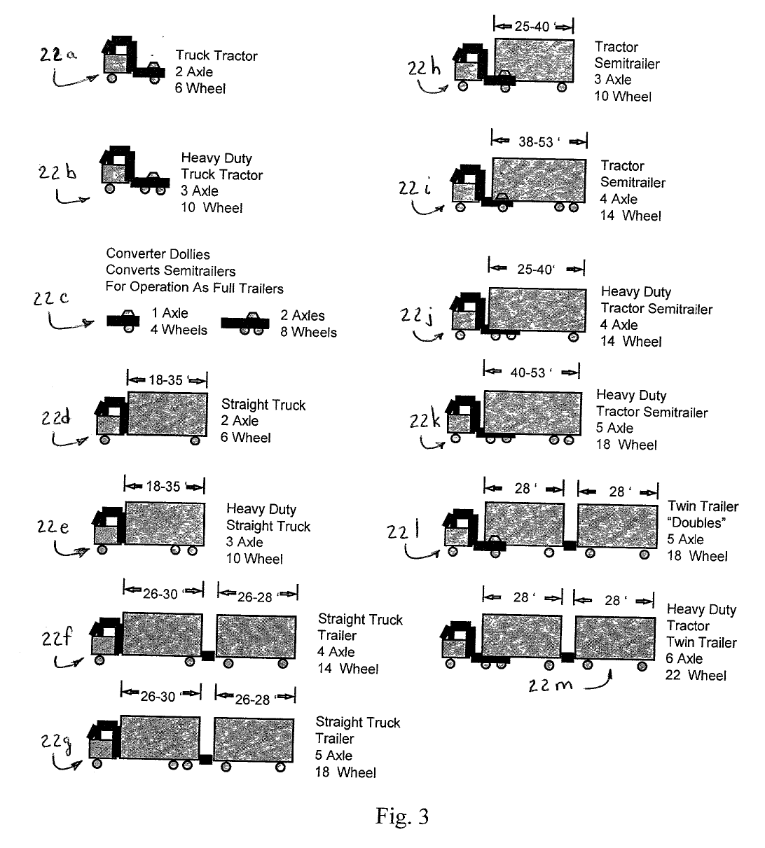

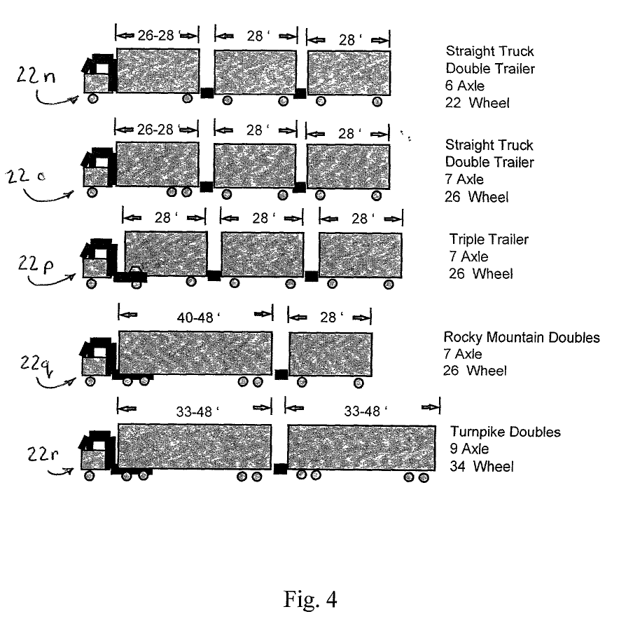

The present invention is directed toward a set of diverse vehicles illustrated by the configurations 22a . . . r shown in FIGS. 3 and 4. FIG. 3 shows typical vehicles that may be found operating throughout the North American commercial trucking market. FIG. 4 shows typical longer combination vehicles that are restricted to operation in certain states of the U.S.A. The system operation and preferred embodiment of invention will be described in the context of the typical applications shown in FIGS. 3 and 4.

A key element to the operation of the present invention is the wheel identification and assignment function. This function permits wheel assemblies randomly installed at any location on the vehicle to be identified and assigned to the exact operating configuration of the vehicle.

Examination of FIGS. 3 and 4 reveals a diverse set of vehicle configurations that employ up to 9 axles and up to 4 wheels per axle. The following axle and wheel assignment convention for each pressurized wheel assembly location is utilized in the present invention:

Wheel Location a#w#

where a# refers to the vehicle axle number 1 through 9 and w# refers to the wheel number 1 through 4 that may be located on a given axle. The axle count starts at the front of the vehicle and proceeds to the rear. The wheel count starts at the driver's side of the vehicle and proceeds to the passenger side (i.e. from the farthest left to the farthest right when facing forward in the cab).

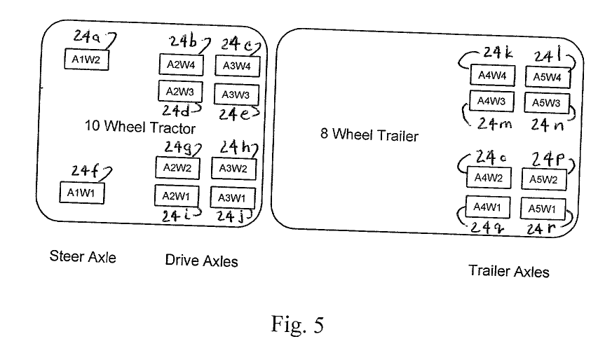

By way of example, the location of the wheel assemblies 24a,b, . . . in a conventional 18W heavy-duty tractor/semi-trailer truck are assigned as shown in FIG. 5 where:

“A1” is the steer or FIRST VEHICLE AXLE.

“A2” is the first drive or SECOND VEHICLE AXLE.

“A3” is the second drive or THIRD VEHICLE AXLE.

“A4” is the first trailer or FOURTH VEHICLE AXLE.

“A5” is the second trailer or FIFTH VEHICLE AXLE.

“W1” is the FIRST WHEEL from the driver's side of the vehicle on a given axle.

“W2” is the SECOND WHEEL from the driver's side of the vehicle on a given axle.

“W3” is the THIRD WHEEL from the driver's side of the vehicle on a given axle.

“W4” is the FOURTH WHEEL from the driver's side of the vehicle on a given axle.

Each WMA 12 contains temperature and pressure sensors and other associated electronic devices described below required to properly operate the wheel module assembly. The pressurized wheel assemblies can be randomly installed anywhere on the vehicle. Consequently, each wheel module assembly must contain a unique identifying number that can be processed and uniquely associated with the transmitted wheel assembly temperature and inflation pressure data. Additionally, the vehicle installation location of each wheel module assembly 12 must be precisely known by axle number and wheel position, i.e. temperature and pressure data must be uniquely associated with a specific wheel installation location 24a,b, . . . (a#w#). The method utilized to produce this association in the present invention is designated as the wheel identification and assignment function. The circuitry required to implement this function is located in the CDU 14 and the WMA 12. Collectively, this circuitry is designated as the wheel probe interface circuitry.

WMA 12 contains its own battery power source, signal conditioning , microprocessor, and transmission circuitry to allow the acquired sensor data, unique identifying number, and the WMA health and status data (e.g. battery voltage) to be transmitted via a RF communication link to the CDU 14.

The exact installation location of each wheel module assembly in the vehicle is determined by the CDU through the wheel probe interface. The WMA contains wheel probe circuitry that allows it to be interrogated in the wheel identification and assignment process.

The CDU 14 functions as a multi-function operator interface to the VWMS 10. It is docked in the PCU 16 during routine monitoring operations. The operator normally commands the system through a computer display unit keypad based control system. The VWMS provides information to the vehicle operator through a visual display and audible alarm system.

The CDU receives the WMA transmitted RF signal through an antenna internal to the CDU. The CDU processes the received signal and recovers the WMA transmitted data. The recovered data is processed and examined for unsafe or inefficient operating conditions in the wheel assembly. The CDU prepares the processed data for display and annunciation.

The display system shows the driver the status of the operating temperature and pressure of each wheel assembly during normal monitoring operations. Audible and visual indicators alert the operator whenever the VWMS determines that a wheel assembly is operating in an inefficient or unsafe condition. Detailed information regarding the offending wheel assembly is provided to the operator through the visual display and audible alarm system.

A pressure sensor is included in the CDU 14 in order to determine local ambient pressure. The CDU processes this pressure data in conjunction with the WMA data in order to determine the operating gauge pressure of the vehicle wheel assembly.

Access to the VWMS is also provided through a RS232 serial data communication port. The port is utilized to provide an interface to equipment external to the VWMS. Such equipment could include test and diagnostic systems, satellite data communication systems, or maintenance and repair depot equipment.

The CDU can be removed from its normally docked position in the Power Cradle Unit and operated as a portable “at the wheel” tire pressure gauge. The CDU is also utilized at the wheel to acquire vehicle configuration data. Specifically, through the wheel probe interface, the CDU acquires the unique WMA identifying number assigned to each wheel position of the vehicle.

Normal operation of the docked CDU is from fused and filtered power received from the PCU 18. When removed from its normally docked position for portable operations, the CDU operates on its own internal power source.

The PCU is mounted inside the vehicle's cab at a location that provides easy access by the vehicle operator. The PCU 16 functions as a docking station for the CDU 14. The PCU furnishes fused and filtered vehicle input power from the PCA to the CDU. It also provides a feed through function for the serial RS232 data port interface between the CDU and external system equipment.

Power from the vehicle's 12 v power system is routed through the PCA to the PCU. Both switched and essential (unswitched) vehicle 12 v power inputs are provided through the PCA to the PCU.

The CDU 14 functions as the normal operator interface to VWMS. It is docked in the PCU during normal operations. The operator commands the VWMS 10 through a menu driven keypad control system in the CDU 14. The VWMS provides information to the operator through a visual display and audible alarm system.

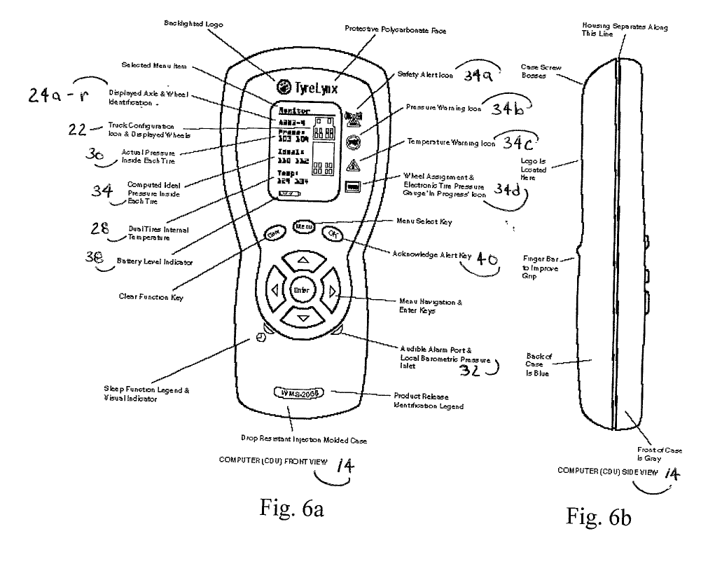

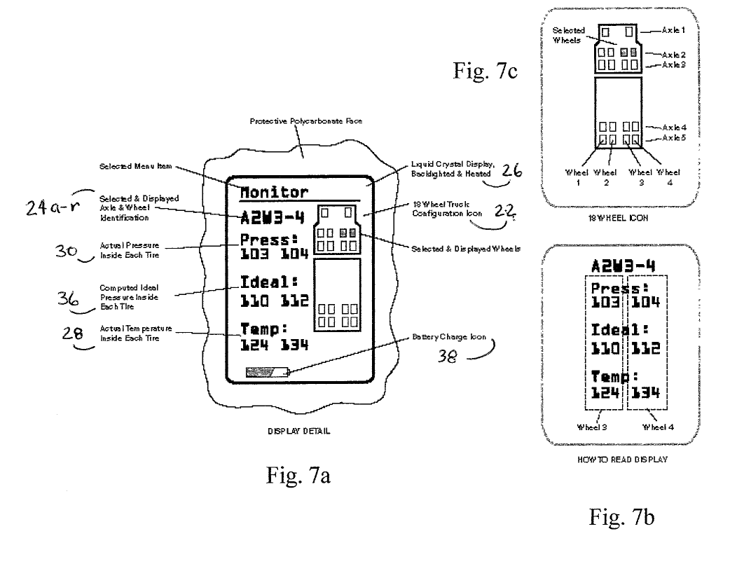

FIGS. 6a-b, 7a-c and 8a-d illustrate the CDU 14 operator interface. The display system 26 illustrated in FIG. 7a shows the driver the status of the operating temperature 28 and pressure 30 of each wheel assembly 24a,b . . . during normal monitoring operations. Audible 32 and visual 34a-d indicators alert the operator whenever the VWMS determines that a vehicle wheel assembly is operating in an inefficient or unsafe condition. Detailed information regarding the offending wheel assembly is provided to the operator through the visual display system. Information is presented to the operator via a liquid crystal display 26 (LCD), a light emitting diode (LED) array 34a-d, and an audible alarm 32.

FIGS. 7a-c illustrates typical information presented on the LCD 26 for an 18-wheel tractor-trailer vehicle operating in the normal Monitor Mode. The LCD contains vehicle icon 22 and alpha-numeric data. An icon corresponding to the specific configuration of the vehicle 22 is shown. The wheel locations in the icon for which alpha-numeric data is being shown are highlighted and identified by axle number and wheel location 24a,b . . . . In this 18-wheel example, wheel 4 on axle 2 is operating at 104 psig and 134° F. The ideal inflation pressure 36 for this wheel operating at this temperature is shown to be 112 psig. An icon 38 showing the charge condition of the CDU portable power source is also displayed. In this example, an approximate charge level of two-thirds is shown.

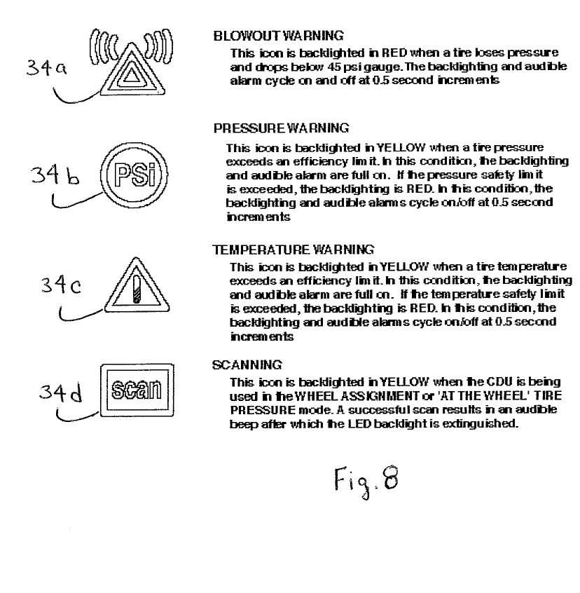

A red/yellow LED array 34a-d is utilized to illuminate the alert icons shown in FIG. 8. A blue LED backlights a logo to serve as a CDU power on indicator. A green LED is illuminated when the driver sleep function is enabled in the CDU. The sleep function allows the visual display LCD backlight, LED icons backlights, and the audible alarm to be suppressed for a selected time period while the driver is sleeping in the vehicle.

The audible alarm is a single tone single tone device capable of being turned on or off in conjunction with an appropriate change in state of the LCD 26 and LED indicators 34a-d. The audible alarm port also serves as the local barometric pressure sensor inlet port. The driver must press the acknowledge alert key 40 to suppress the audible warning tone.

The present invention is structured to operate as a state machine utilizing a main polling loop. The main polling loop watches for inputs from the CDU keypad or WMA transmissions. The input data as well as the current state of the system determines how a particular input is processed.

The operating modes of the VWMS 10 include the following:

System Initialization Mode

Monitor Mode

Wheel Module Message Processing Mode

Driver Alert Mode

Menu Mode

Configuration Mode

Assign Wheels Mode

Set Pressure Mode

Set Limits Mode

Tire Gauge Mode

Sleep Mode

Maintenance Menu Mode

History Log Mode

Download Data Mode

Factory Diagnostic Mode.

The RS232 serial data interface is utilized as a means to examine the internal operations of the VWMS. In the event that a user requests a data output transfer through the RS232 test interface, the system will export the contents of all CDU data storage queues, in ASCII comma delimited form, to the requesting external device. A standard RS232 protocol and cabling system may be employed.

The VWMS 10 provides the driver with optimum operating tire pressure information. The VWMS alerts the driver when the wheel assembly temperatures or pressures breach operator selected efficiency limits. Additionally, the CDU automatically informs the operator as to whether or not the wheel assembly temperatures and pressures are within safe operating conditions.

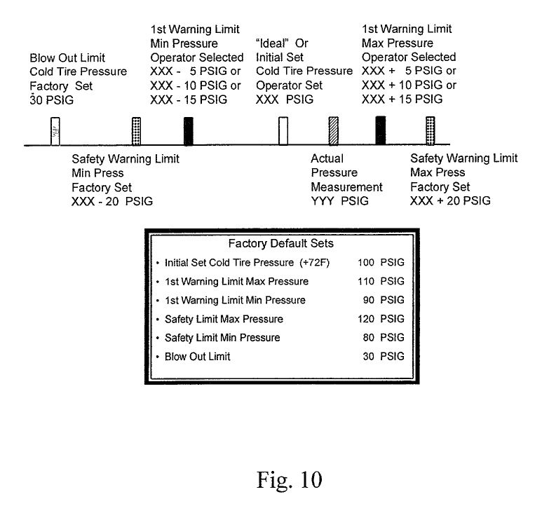

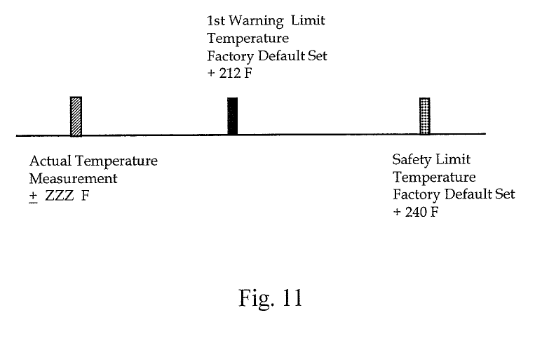

The operator is permitted to set the ideal inflation pressure and corresponding alert limits he desires for each axle of the vehicle for an operating condition of 72° F. at sea level. The “ideal” inflation pressure is automatically compensated for wheel assembly operating temperature changes from the 72° F. set point. The pressure alert limits are also compensated for wheel assembly operating temperature changes. The alert limits automatically track the “ideal” inflation pressure for operating wheel assembly temperature changes. FIGS. 10 and 11 illustrate the caution and warning alert factory default settings and the operator adjustable limits.

The VWMS also functions as an “at the tire” electronic tire pressure gauge. When utilized in this manner at the tire, the VWMS provides actual and ideal tire pressure information to the operator. The indicated pressures presented to the operator automatically compensate for temperature changes in the wheel assembly (i.e. the operator is presented with the ideal inflation pressure at the time of the actual inflation pressure measurement regardless of whether or not the wheel assembly is hot or cold). It automatically compensates for changes in operating altitude.

Pressures in the VWMS are measured in PSIA units by the pressure sensors. The VWMS displays measured pressures to the operator in PSIG units. These units are defined as follows:

PSIA—Pounds per Square Inch Absolute is the pressure measured by a sensor in absolute terms against a reference pressure of zero absolute (i.e. a hard vacuum). The WMA measures wheel assembly pressure in PSIA units. The CDU measures local ambient atmospheric pressure in PSIA units.

PSIG—Pounds per Square Inch Gauge is the pressure indicated on a tire pressure-measuring gauge. The gauge pressure for a wheel assembly is determined by subtracting the local ambient atmospheric pressure measured by the CDU sensor from the inflation pressure measured by the WMA sensor.

PSIG=P_{Gauge}=P_{WMA}−P_{CDU} where P_{WMA} and P_{CDU} are measured in PSIA units.

A tire's inflation pressure will present an apparent change in gauge pressure as a function of altitude. The VWMS automatically compensates for altitude effects on pressure measurements. A barometric correction pressure measurement is defined as follows:

Barometrically Corrected Pressure is the gauge pressure correction factor that is determined by subtracting the local ambient atmospheric pressure measured by the CDU in PSIA units from the absolute pressure of one standard atmosphere at sea level.

P_{Baro}=P_{Ambient}−P_{Std} where P_{Baro}, P_{Ambient} and P_{Std} are expressed in PSIA units.

The present invention utilizes P_{Baro} to correct gauge pressure measurements for vehicles operating above or below sea level.

A constant volume tire is an inflatable tire that does not change to any operationally significant degree upon inflation at various operating pressures and temperatures and obeys Boyle's Law for a closed pressurized volume. Tire manufacturers have stated that tires maintain a constant volume over the safe operating range of the tire. For purposes of pressure measurements in the VWMS all tires are “constant volume tires.” Boyle's Law determines the temperature compensated pressure inside a constant volume closed vessel. The following algorithm is derived: and utilized in the present invention for computing temperature correct “ideal inflation pressure” and pressure alert limits:

If (P V)/(T)=Constant according to Boyle's law

then [(P1 V1)/T1]=[(P2 V2)/T2]=Constant

and P2=(P1 T2 V1)/(T1 V2)

where P2=Pressure at T2 and P1=Pressure at T1

Assuming V2=V1 (constant volume)

then P2=(P1 T2)/(T1) where P=PSIA and T=Degrees Kelvin

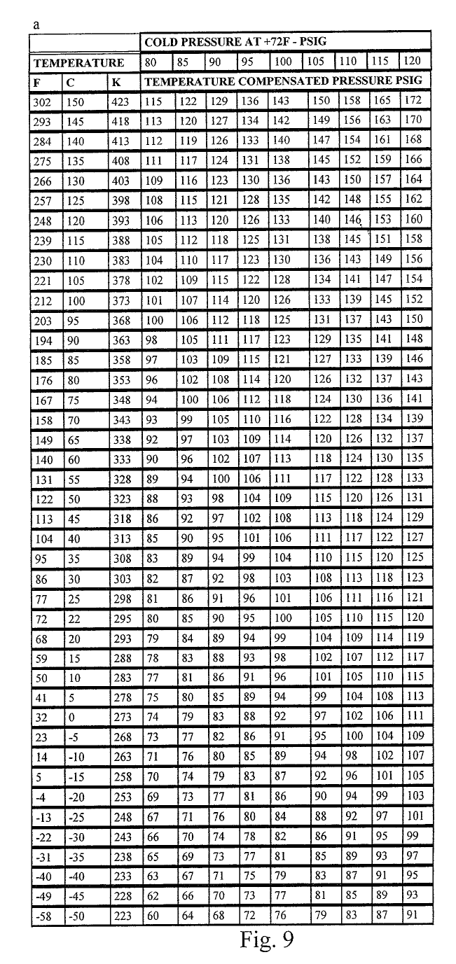

The present invention utilizes the derived P2 algorithm to automatically compensate the “ideal” inflation pressure and tire pressure measurements as a function of wheel operating temperature. The temperature effects on indicated gauge pressure for various initial tire inflation pressures at +72F are shown in FIG. 9.

The present invention operates with an Ideal Inflation Pressure indication and a correlated set of caution and warning Alert Limits that are established in four warning limit categories as illustrated in FIGS. 10 and 11:

“Ideal Inflation Pressure”—Through the CDU control interface, the operator sets the ideal initial operating tire pressure for each vehicle axle set in the VWMS. This pressure is specified for a “cold” wheel assembly operating condition of +72F at sea level and expressed as xxx PSIG. The VWMS computes the barometrically corrected and temperature compensated Ideal Inflation Pressure that the operator uses as a target for the optimum inflation pressure when he is inflating a vehicle's tires.

“First Warning Limit”—These caution limits are used in alerting a driver to an inefficient operating condition but still within a safe operating range:

Pressure—The operator is able to set the First Warning Pressure Limits for each axle set in the VWMS. The allowable limits are ±5,±10, or ±15 PSIG centered about the Ideal Inflation Pressure (xxx PSIG) as shown in FIG. 10. This limit is temperature and barometrically compensated in.

Temperature—The First Warning Temperature Limit is factory set to +212F as shown in FIG. 11. It is changeable by the operator.

“Safety Warning Limit”—These safety-warning limits are used to alert the driver to an operating condition that breaches a pre-determined Safety Warning Limit.

Pressure—The Safety Warning Pressure Limits for each axle set are factory set to ±20 PSIG centered about the Ideal Inflation Pressure xxx PSIG as shown in FIG. 10. It shall not be changeable by the operator. This limit is temperature and barometrically compensated.

Temperature—The Safety Warning Temperature Limit shall be factory set to +240F as shown in FIG. 11. It is changeable by the operator.

“Dual Pressure Warning Limit”—Dual wheel assemblies in the vehicle are monitored for differential pressure. The driver is alerted when the differential pressure in a set of dual wheels exceeds 5 PSIG. The driver is also warned when the differential pressure between the steer axle tires exceeds 5 PSIG.

“Blow Out Warning Limit”—This operating limit is used to alert the driver of a catastrophic pressure change. A Blow Out condition is deemed to have occurred whenever the tire pressure catastrophically falls below 45 PSIG after having once been inflated above 30 PSIG. This limit is shown in FIG. 11.

All caution and warning limits are temperature compensated and barometrically corrected. They are initially set for operation at sea level and 72F.

Limits are deemed breached in the VWMS only after the limit number has been exceeded, not equaled. For example, a tire pressure reaching 90 PSIG has not breached a 100 PSIG ±10 PSIG limit. The limit is breached once the compensated pressure reaches 89 PSIG or lower pressure. When a limit is breached, an appropriate set of alert actions are taken using the LCD, LED, Audible Alarm, and Acknowledge key devices shown in FIGS. 6, 7, and 8. Both the “First Warning” and the “Safety Warning” alert actions are repeated five (5) times at thirty (30) minute intervals if the condition causing the limit breach does not correct itself. The “Blow Out” Alert condition is only shown once. For this condition, when the Acknowledge key is depressed by the operator, it will not show again. However, the Blowout icon will continue blinking until the safety issue condition is resolved.

If the First Warning Alert or the Safety Warning Alert conditions persist past 30 minutes, the VWMS repeats the appropriate warnings specified in FIG. 8 through five (5) repetitions at 30 minute intervals. The operator either continuously listens to the Audible Alarm or presses the Acknowledge key to reset the system. Each time the Acknowledge key is depressed, the Audible Alarm is turned off and the event data is logged to an event file. In 30 minutes, the breach is displayed again with full alarm conditions. After the 5th time the Acknowledge key is depressed, the system ignores the limit breach at that location until the switched power to the system is turned off. Upon a system power-up re-start, the VWMS re-initializes and begins anew.

Whenever the VWMS detects that a WMA in the assignment queue is not sending a signal to the CDU, the operator is alerted by removing that wheel assembly from the vehicle icon shown in FIG. 7. The missing WMA failure mode is declared to have occurred when no signal is received by the CDU from the subject WMA for a period of 225 minutes or more. When the Acknowledge key is depressed, the Audible Alarm is turned off and the event data logged to the event file. Upon a system power-up re-start, the VWMS re-initializes and begins anew. The Missing Wheel Module Assembly Warning function is suspended whenever the CDU is off of the PCU.

Whenever the VWMS detects any system failures, the operator is alerted. By way of example, the following two operational System Failure warning conditions are declared to have occurred whenever the following conditions are met:

| Operational Failure | Conditions |
|---|---|
| Computer Display Unit Too Hot | CDU reaches temperature above 185 F. |
| Local Ambient Pressure | Barometric Pressure <11 PSIA or >20 |
| Sensor Failure | PSIA |

If there are multiple conditions that are causing a breach caution and warning alert, a prioritized display scheme is employed for the breaching system condition or wheel assembly location. The appropriate highest priority breach condition is shown on the display. The priorities are as follows:

1. Computer Display Unit Too Hot System Failure Warning

2. Barometric Pressure System Failure Warning

3. Below Blow Out Warning pressure limit

4. Below Safety Warning minimum pressure limit

5. Above Safety Warning temperature limit

6. Above Safety Warning maximum pressure limit

7. Above Dual Warning pressure limit

8. Below First Warning minimum pressure limit

9. Above First Warning temperature limit

10. Above First Warning maximum pressure limit

11. Missing Wheel Module Assembly Warning

All caution and warning alert events are time and date stamped and logged into a history file in the CDU.

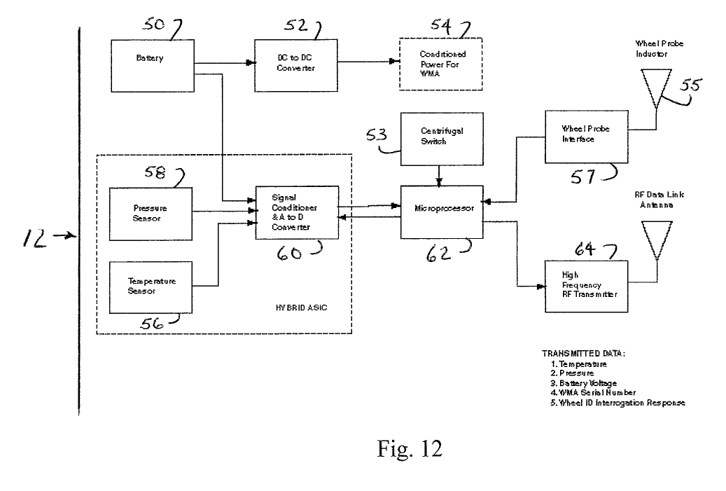

Referring to the block diagram shown in FIG. 12, the WMA 12 is powered from a high energy density thionyl chloride battery 50 that is designed to last beyond the guaranteed minimum operational life of the WMA. An energy efficient switching dc-dc converter 52 provides conditioned power 54 for the WMA circuitry.

The WMA contains a temperature sensor 56 and an absolute pressure sensor 58. The sensor outputs and the battery voltage output are routed to a signal conditioner 60 where they are processed for the microprocessor 62 interface. A crystal controlled clock drives the microprocessor. The microprocessor and its associated memory devices maintain a unique identifying number for the WMA. The acquired sensor data, unique identifying number, battery voltage, and other pertinent WMA health and status indicator data are packetized by the microprocessor for transmission via a Manchester II encoded wireless data communication link 64 to the CDU. The RF transmitter 64 operates with an on-off keying (OOK) modulation system. The bow tie shaped transmit antenna is operated at 916.5 MHz. An error detection and correction function is incorporated into the data transmission system. The transmitted data is encoded with an error detection and correction code in the WMA. The received WMA data transmission is error checked and corrected in the CDU.

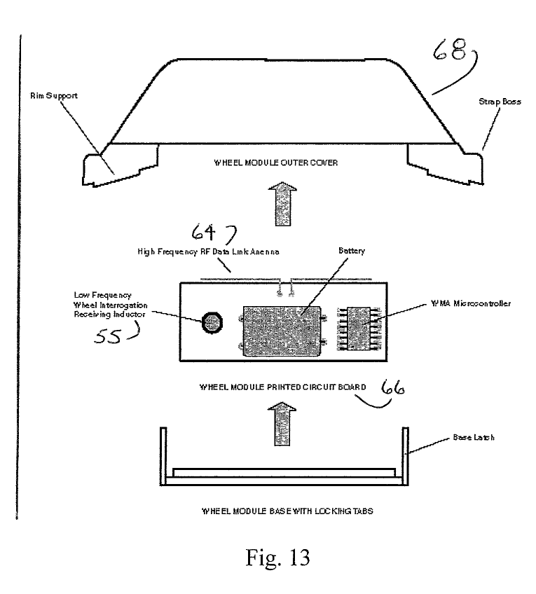

The WMA electronics and transmit antenna 64 are mounted on a single four layer printed wiring board 66 and installed into an injection molded plastic housing 68 as shown in FIG. 13. The housing serves as a debris shield for the electronics against water, ice, and other particulates inside the tire. The circuit board and its antenna are conformally coated to afford further protection of the WMA electronics in the operating environment.

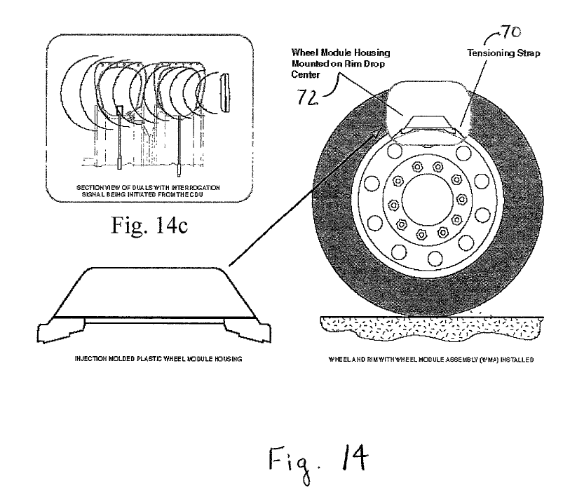

A tensioning strap 70 mounts the WMA on the drop center 72 of the rim inside the tire at the valve stem as shown in FIG. 14. The tensioning strap is constructed of stainless steel for steel wheel installations and aluminum for aluminum wheel installations. A spring loaded screw type tensioning mechanism in conjunction with the matched metal bands are utilized to compensate for the change in diameter of the wheel over temperature. Utilizing stainless steel bands on steel wheels and aluminum bands on aluminum wheels also facilitates galvanic corrosion control measures. Each tensioning strap is designed to accommodate both 22.5 and 24.5 inch wheels.

A double seal valve cap with a distinctive color band is attached to those wheel assemblies of the vehicle that have WMA's installed in them. This valve cap allows a vehicle operator to quickly assess by a visual inspection which wheel assemblies have wheel modules installed in them. A benefit of the double seal valve is that the leak rate of the wheel assembly will be reduced since most air loss in tires without punctures is through the valve stem. The additional sealing of the valve stem with the double seal cap will reduce the leak rate of the tire.

The WMA is shipped and stored in a quiescent state to preserve battery life. In this quiescent state, the WMA is not enabled to transmit. The WMA is enabled to transmit only when installed into a vehicle wheel assembly and pressurized above 30 PSIG. After pressurization above 30 PSIG, the WMA begins its normal operations and the WMA operating life period begins.

The WMA normally rests in its lowest power consumption state after manufacture during the shipping and storage period. After the initialization sequence has been completed, the WMA begins normal data acquisition and transmission operations. The WMA microprocessor acquires the following data samples every 6 seconds through the signal conditioner:

Wheel Assembly Pressure (P)

Wheel Assembly Temperature (T)

Battery Voltage (V)

These current data samples are stored in the WMA after acquisition. The microprocessor then examines the data. The WMA then transmits the current data appended to the unique WMA identification data (ID) over the wireless data communication link to the CDU under the following conditions:

| Condition | | WMA Action |
|---|---|---|
| 1. | Time since last data sample ≧90 minutes? | Yes—WMA initiates an immediate |
| | | transmission of the current P, T, V data |
| | | sample with ID data appended. The WMA |
| | | then enters a low power state and waits for |
| | | the next 6-second sample period to begin. |
| | | No—WMA examines the change in P, T, V |
| | | data with respect to the last sample. |
| 2. | Change in P, T, V data with respect to | Yes—WMA initiates an immediate |
| | the last sample ≧3.125 percent? | transmission |
| | | of the current P, T, V data sample with ID |
| | | data appended. WMA then enters low |
| | | power state and waits for next 6-second |
| | | sample period to begin. |
| | | No—WMA examines the P data for a blow |
| | | out condition. |
| 3. | P < 45 PSIA? | Yes—WMA initiates an immediate |
| | | transmission of current P, T, and V data |
| | | sample with ID data appended. The WMA |
| | | then determines the number of consecutive |
| | | transmissions with P < 45 PSIA. |
| | | No—WMA enters low power state and waits |
| | | for the next 6-second sample period to begin. |
| 4. | Number of consecutive transmissions | Yes—WMA enters a low power state |
| | >5 with P < 45 PSIA? | and terminates all further data transmissions |
| | | until P > 45 PSIA. When P > 45 PSIA again, |
| | | the WMA executes the WMA initialization |
| | | sequence and begins normal operations. |
| | | No—WMA enters low power state and waits |
| | | for the next 6-second sample period to begin |

The design of the VWMS is intended to meet the technical, labeling, and operational requirements of the Code of Federal Regulations (CFR), Title 47 , Part 15 , Telecommunications. The design of the WMA transmitter is such that an individual license is not required for each WMA or application of the VWMS. With respect to the specific requirements of Section 15.231, each WMA is considered to be operating in a safety system application as a polling or supervision transmitter. The periodic rate of transmission of each WMA transmitter when operating in a non-emergency condition does not exceed one transmission of not more than one second duration per hour for each transmission. During an alarm condition, the WMA may transmit as required during the pendency of the alarm condition.

The CDU serves as a multi-function operational interface to the VWMS. This interface is shown in detail in FIGS. 6, 7, and 8.

It should be noted that elements of the operational interface can be disabled by the operator to permit him to sleep in the vehicle without interruption. The operator temporarily disables the LCD backlight, backlit caution and warning icon LEDs, and the audible alarm when the system is placed in the Sleep Mode. In this mode, the operator is allowed to select a sleep period in which he does not wish to be disturbed by the caution and warning system alerts; however, the system continues to operate during this period until the sleep period expires. The system automatically resumes normal operation at the end of the sleep period. All alerts that were suppressed during the sleep period are annunciated at the end of the sleep period.

Several features of the CDU drop impact resistant housing design are noted in FIG. 6. The CDU electronics are located on a single multi-layer board in the CDU. The housing is environmentally sealed to afford protection for the CDU electronics. It should be noted that a single port in the housing serves as the audible alarm output and the barometric pressure sensor inlet. Moisture protection at that port is achieved through the use of a Gortex baffling material that is waterproof but allows the housing to breathe.

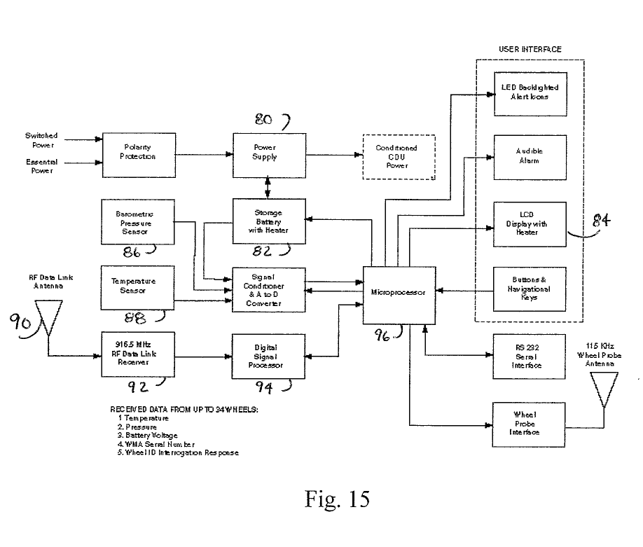

FIG. 15 is a block diagram of the CDU 14. The VWMS is structured to operate as a state machine. The operating system instructions used in the state machine are executed by the CDU microprocessor. The operating system is stored in the memory devices associated with the CDU microprocessor.

A main polling loop runs in the microprocessor for the entire time that the CDU is powered up. It watches for inputs from the CDU keypad or WMA transmissions. The input data as well as the current state of the system determines how a particular input is processed. The operating system enables the VWMS to operate in the following modes:

System Initialization Mode

Monitor Mode

Wheel Module Message Processing Mode

Driver Alert Mode

Menu Mode

Configuration Mode

Assign Wheels Mode

Set Pressure Mode

Set Limits Mode

Tire Gauge Mode

Sleep Mode

Maintenance Menu Mode

History Log Mode

Download Data Mode

Factory Diagnostic Mode.

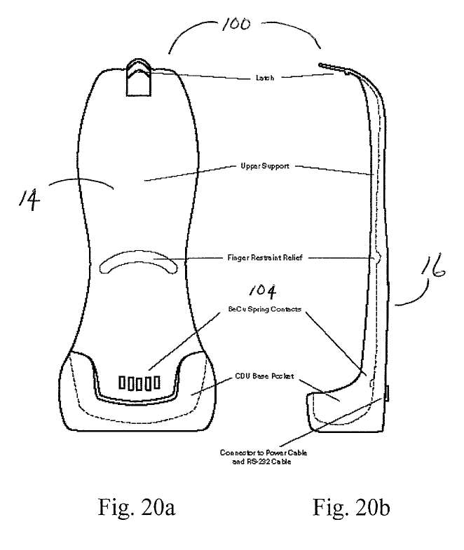

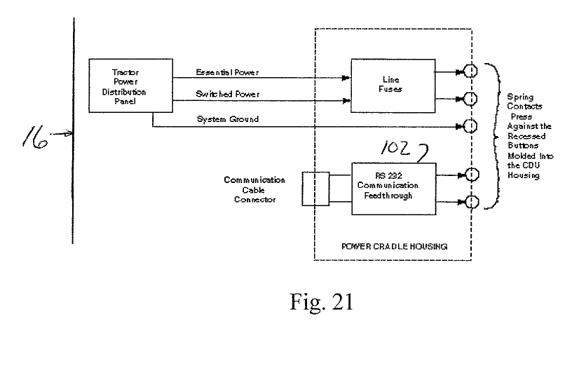

During normal operation in the Monitor Mode, the CDU is docked in the PCU. Normal operation of the docked CDU is from fused and filtered power received from the PCU as shown in FIGS. 20a and 20b. The CDU is protected from polarity reversal from any of the external or internal power sources. All external power polarity protection mechanisms are electronically implemented (i.e. they are electronically resetable and do not require physical replacement after a fault is incurred). The CDU operates from PCU supplied power when cradled and from the storage battery when uncradled. Regulated power is derived from these power sources and supplied to the CDU electronics by the power supply shown in FIG. 21.

When removed from its normally docked position for portable operations, the CDU operates on its own internal power source 80. The internal power source is rechargeable. The CDU contains a thermal management system for cold weather operations. This system controls component heaters 82 and 84 in the rechargeable CDU battery system and the liquid crystal display.

Local ambient pressure is acquired through a barometric pressure sensor 86 in the CDU. The CDU utilizes this pressure in the computation of gauge pressures as previously described in this specification. Operating temperature information required for the thermal management system is acquired through a temperature sensor 88 located in the CDU.

RF transmissions from the WMA's are received through a fan shaped antenna 90 that is integral with the CDU circuit card assembly. The packetized data stream is recovered from the received 916.5 MHz signal 92 in the digital signal processor 94 and presented to the microprocessor 96 for further processing. That processing includes error detection and correction actions for the received data stream and processing of the received WMA temperature, pressure, battery voltage, and WMA identification data.

A mandatory requirement for the VWMS is that the transmitted WMA data be unambiguously linked to the installed operating wheel location in a given vehicle (i.e. must be able to differentiate transmitted information by installed wheel location in a given vehicle). The method utilized to produce this association in the present invention is designated as the Wheel Identification and Assignment function. The circuitry used to implement this function is distributed between the CDU and the WMA. Collectively, this circuitry is designated as the Wheel Probe Interface circuitry.

The exact installation location of each WMA in the vehicle is determined by the CDU through the use of the Wheel Probe Interface circuitry shown in FIGS. 12 and 15. The centrifugal switch 53 shown in FIG. 12 is used to ensure that the Wheel Identification and Assignment function is disabled in the WMA when the vehicle is moving. This switch helps to improve the electromagnetic interference rejection capabilities of the system during normal trucking operations.

The present invention utilizes a “Wheel Probe” electromagnetic coupling technique to identify and assign the installation location of each WMA in the vehicle. A source coil in the CDU is energized and utilized as a transmitting antenna to radiate electromagnetic energy. A coil located in each WMA is used as a receiving antenna to intercept the electromagnetic energy transmitted from the CDU. After detecting radiated energy during the scan, the WMA immediately transmits requisite information to the CDU.

Using this technique for WMA location assignment, the CDU enters the Assign Wheels Mode of operation and interrogates WMA's in the vehicle. An inductive low frequency transmitter operating in the 100-150 KHz frequency range in the CDU radiates enough energy to excite a ferrite core inductor based receiving antenna in the WMA. The radiated energy is intercepted by the WMA Wheel Probe Interface circuitry shown in FIG. 12, which activates the WMA microprocessor and initiates an immediate RF data link transmission that would be received by the portable CDU. That transmission would include wheel operating temperature, pressure, battery voltage and a unique WMA identification serial number. The serial number data would then be transferred to the subject wheel location in the CDU and the current wheel operating temperature, tire pressure, and WMA battery voltage data logged.

In using the Wheel Identification and Assignment Function, the operator removes the portable CDU from the cab and moves to the wheel location that needs to be identified and assigned. The assignment is done for two wheels at a time at dual wheel assembly locations in the vehicle (e.g. dual wheel locations on the drive axle). It is done for one wheel at a time at single wheel assembly locations in the vehicle (e.g. the steer axle wheel locations).

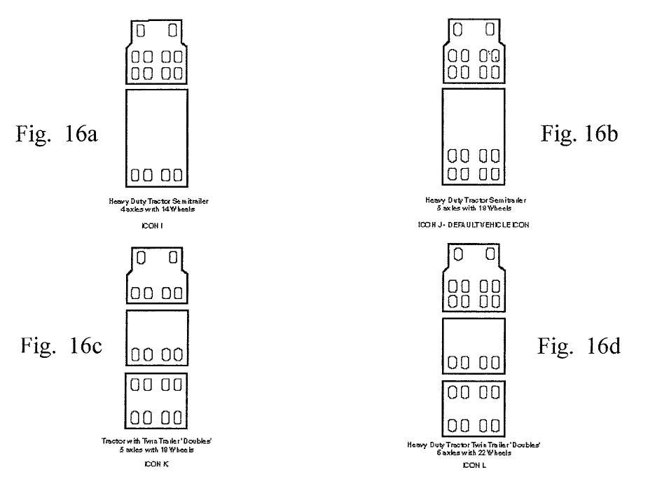

The operator first enters the Menu Mode and then the Configuration Mode. In the Configuration Mode the operator insures that the correct icon 22 is selected for his vehicle. Examples of some of the icons from which the operator may select are shown in FIG. 16.

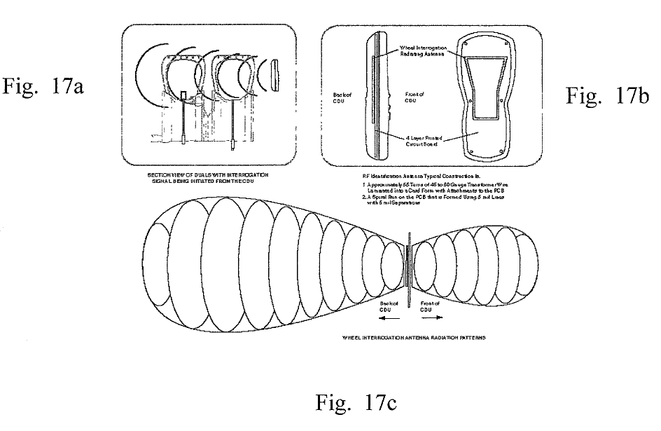

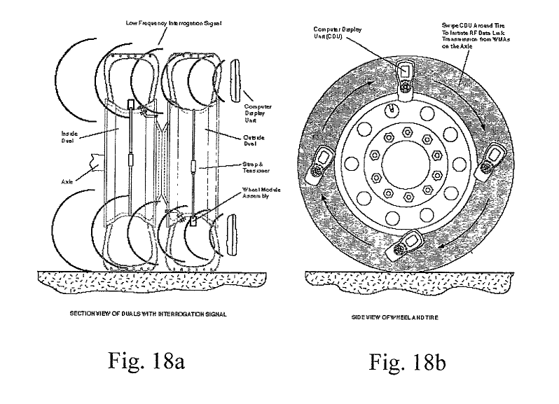

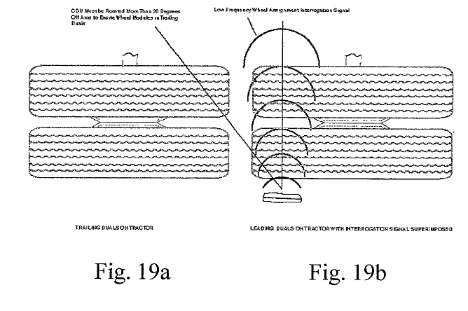

The operator then uses the CDU menu navigation keys to enter the Assign Wheels Mode. He engages the Wheel Identification and Assignment function and selects the wheel assemblies he wants to assign. The operator then initiates the scanning process in the CDU and the “SCAN” icon shown in FIGS. 6 and 8 is illuminated. When the “SCAN” icon is illuminated, a low frequency signal is radiated from the CDU Wheel Probe Interface interrogation antenna 100 as shown in FIG. 17. Holding the CDU parallel to a plane normal to the subject wheel axle, the operator swipes the CDU in a parallel plane around the tire as shown in FIG. 18a-b. In the swiping motion around the tire, the operator must insure that the back of the CDU is held parallel to the tire within a ±30 degree angle as shown in FIG. 19. Also, the operator must insure that the valve stems on the wheels being assigned are included in the area swept by the circular motion shown in FIG. 17. This inclusion insures that the subject WMA's are irradiated by the CDU interrogation signal because each WMA is located near the valve stem of the vehicle wheel.

The interrogation signal is intercepted in the WMA by the low frequency wheel interrogation receiving inductor 55 shown in FIGS. 12 and 13. After the interception, the Wheel Probe Interface circuitry 57 shown in FIG. 12 notifies the WMA microcomputer 62 that an interrogation signal has been detected. The WMA microcomputer then initiates a normal RF data link transmission that is received by the portable CDU that is in the Assign Wheels Mode. The CDU immediately processes the data packet transmitted by the interrogated WMA. The received unique identifying number transmitted by the interrogated WMA is then transferred to the selected wheel location in the CDU and the current tire pressure and temperature and battery voltage logged for that location. The operator is then notified of a successful interrogation through the CDU audible alert annunciator. All future data packets received with that unique identifying number would then be associated with that wheel location in the VWMS. The operator then moves to the next wheel location to be assigned and repeats the process until all of the wheels in the vehicle are assigned.

The transmitted WMA data packets are unambiguously linked to the installed vehicle wheel location in a given vehicle. The VWMS is designed to accept only transmitted information from its installed WMA's. In a situation when one or more vehicles utilizing the present invention are in close proximity to each other, the information from adjoining vehicle WMA transmissions are rejected in the VWMS. The present invention is also designed to reject information from WMA's that have not yet been assigned to a wheel location in that vehicle. However, during the Assign Wheels Mode, the CDU will accept the data transmission from the WMA's being interrogated.

External equipment access to the VWMS is provided through the RS232 serial data communication port shown in FIG. 19. The RS232 port serves as the primary test interface during testing operations. This port is utilized as a means to examine the internal operations of the VWMS. In the event that a user requests a data output transfer through the RS232 port, the system is capable of exporting the contents of all CDU data storage queues, in ASCII comma delimited form, to the requesting external device. This data includes as a minimum the following:

Current system configuration data.

All operator information interface display data.

All received WMA data arrays currently stored by the CDU.

All non-WMA data arrays currently stored by the CDU The CDU processor memory contents.

All current user settable data.

All factory set data.

The factory set data may be changed through the RS232 port; however, such operations can only occur in the Maintenance Menu Mode, History Log Mode, Download Data Mode, or the Factory Diagnostic Mode through password-enabled commands.

The CDU also functions as an “at the tire” non-contacting electronic tire pressure gauge. When utilized in this manner at the tire, the CDU display displays actual and “ideal” tire pressure information to the operator. The indicated pressures presented to the operator automatically compensate for temperature changes in the wheel assembly (i.e. the operator is presented with the ideal inflation pressure at the time of the actual inflation pressure measurement regardless of whether or not the wheel assembly is hot or cold). Electronic tire gauge operations can only be performed after the WMA's have been assigned to their appropriate locations in the vehicle.

In using the electronic tire gauge function of the VWMS, the operator removes the portable CDU from the cab and moves to the wheel location that needs to be measured. The measurement is done for two wheels at a time at dual wheel assembly locations in the vehicle (e.g. dual wheel locations on the drive axle). It is done for one wheel at a time at single wheel assembly locations in the vehicle (e.g. the steer axle wheel locations).

The operator first enters the Menu Mode and selects the Tire Gauge Mode. In the Tire Gauge Mode the operator uses the CDU menu navigation keys to select the wheel assemblies he wants to measure. The current tire pressure and temperature logged and displayed for that location. The operator is notified of a successful measurement through the CDU audible alert annunciator. The operator can now adjust the inflation pressure of the tire to the “ideal” pressure setting. The process is repeated if the operator wishes to recheck the pressure. The operator then moves to the next wheel location to be measured and repeats the process. The CDU is returned to the cradle in the vehicle cab after the measurements are made.

The PCU 16 shown in FIG. 20 is mounted inside the vehicle cab within arm's reach of the vehicle operator in order to facilitate easy access to the VWMS. The PCU functions as a docking station for the CDU in the vehicle cab. A mechanical latching 100 mechanism provides a securely holds the CDU in the cradle.

FIG. 21 is a block diagram of the PCU. The PCU furnishes fused and filtered vehicle input power to the CDU. All power fusing protection mechanisms are electronically implemented (i.e. they are electronically resetable and do not require physical replacement after a fault is incurred). The PCU provides a feed through function for the RS232 interfaces from external equipment to the CDU. The PCU provides electrical contacts for the CDU power and RS232 inputs. Electrical connections between the PCU and CDU are provided through BeCu spring contacts 104 as shown in FIG. 20.

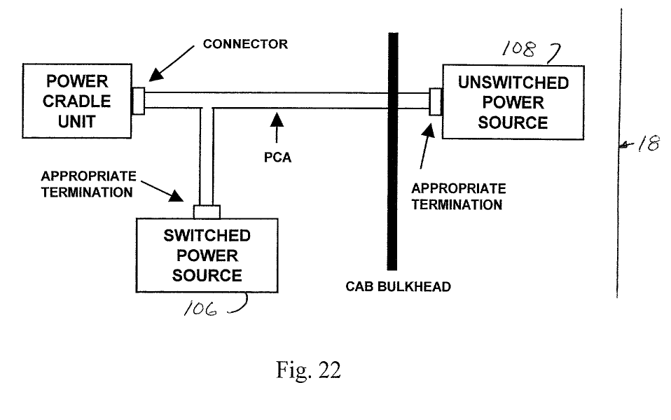

Both switched 106 and essential 108 (i.e. unswitched) vehicle power inputs are provided to the PCU by the PCA as shown in FIG. 22. The PCA is designed in accordance with the requirements of SAE J1455. An appropriate marking system (e.g. color coded conductors, imprinted alpha-numeric labels, tags, etc.) is utilized to clearly identify the vehicle power source cable conductors at the termination points.

The preferred embodiment of the invention could be modified with any or all of the following alternatives.

The implementation of the Wheel Identification and Assignment function and its associated apparatus in the preferred embodiment of the invention would be replaced with an RFID technology implementation. Each pressurized wheel assembly would contain a WMA. Each WMA would contain temperature and pressure sensors. The pressurized wheel assemblies could be randomly installed anywhere on the vehicle. Consequently, each WMA would still contain a unique identifying number that would be processed and uniquely associated with the transmitted wheel assembly temperature and inflation pressure data. In addition, the installation location of each WMA would still be precisely known by axle number and wheel position. The foregoing would still be a mandatory requirement (i.e. temperature and pressure data must be uniquely associated with a specific wheel installation location). This assignment would still be automatically be done within the VWMS.

An RFID tagging or similar technology could be utilized to identify the installation location of each WMA. A Wheel Probe would be located on the CDU for this purpose. Using this scheme for WMA location assignment, an RFID transmitter in the CDU would radiate enough energy to excite an RFID tag molded into the WMA housing. The RFID tag would transmit its data back to an RFID reader in the CDU. In addition, this radiated energy would be intercepted by the wheel module circuitry which will ‘pull a pin’ on the wheel module microcomputer chip and initiate the RF data link transmission that would be received by the portable CDU. The RFID serial number data would then be transferred to the identified wheel location in the CDU and the current tire pressure and temperature logged.

Alternate frequencies other than 100-150 KHz could be utilized in the inductively coupled coil implementation of Wheel Identification and Assignment Function in an alternate embodiment of the invention.

Alternate techniques other than an inductively coupled coil means could be employed to implement the Wheel Identification and Assignment Function. These alternate techniques would employ an interrogation signal transmitting means in the CDU and an interrogation signal receiving means in the WMA. Such means could employ an RF transmitter in the CDU and an RF receiver in the WMA. Another means could employ a permanent magnet field in the CDU and a magnetically operated relay in the WMA. Another means could employ a Hall-effect device in the WMA with an appropriate activation means in the CDU.

The implementation of the Wheel Identification and Assignment function and its associated apparatus in the preferred embodiment of the invention would be replaced with a direct download method. In this implementation the CDU would be utilized at the wheel assembly to download the a#w# location information to the selected WMA. This implementation would require that the WMA be equipped with a receiving means to accept the download information. The CDU would be modified to download the a#w# to the WMA through an RF or electromagnetic coupling means. In this approach, the WMA would transmit it's a#w# data in place of its unique serial number identification data over the wireless data communication link to the CDU.

In using the direct download approach, the CDU could be modified to utilize the valve stem as a means to download the a#w# information. In this method the CDU would connect to the valve stem and utilize the valve stem as a means to radiate the download information to the WMA. Another direct download approach could have the valve stem directly connected to the WMA. In this instance, the CDU would connect to the valve stem and the a#w# information would be directly downloaded to the WMA.

The 916.5 MHz receive antenna in the preferred embodiment of the present invention is integral to the multi-layer PWB in the CDU. This antenna could be replaced with any of the following:

1. A dipole antenna located off of the PWB inside the CDU housing.

2. A “rubber duck antenna” dipole antenna attached to the outside of the CDU housing.

3. An antenna mounted external to the CDU but internal to the vehicle cab in such a manner and location as to provide robust and reliable reception of the WMA transmitted signals. Such an internal cab antenna would be routed through a cable to the CDU and through the PCU. The PCU would provide a feed through function for the external antenna cable. An accommodation would have to be made when the CDU was utilized as an “at the wheel” electronic tire pressure gauge. Another second antenna would be required in the CDU to permit electronic tire gauge operations. The second antenna would be disabled whenever the CDU is docked in the PCU during normal operations.

4. An antenna mounted on the vehicle external to the operator's cab in such a manner and location as to provide robust and reliable reception of the WMA transmitted signals. Such an external antenna would be routed through a cable to the CDU and through the PCU. The PCU would provide a feed through function for the external antenna cable. An accommodation would have to be made when the CDU was utilized as an “at the wheel” electronic tire pressure gauge. Another second antenna would be required in the CDU to permit electronic tire gauge operations. The second antenna would be disabled whenever the CDU is docked in the PCU during normal operations.

The transmit antenna in the preferred embodiment of the present invention is located internal to the WMA housing. This antenna could be replaced with an implementation that would utilize the valve stem as a transmit antenna.

The WMA is attached to the drop center of the rim internal to the tire of a wheel assembly with a tensioning band in the preferred embodiment of the invention. An alternate approach would have the WMA attached to the drop center of the rim through an adhesive system. Yet another approach would utilize a mechanical means to attach the WMA inside the wheel assembly to the valve stem.

The preferred embodiment of the invention was described in the context of its application to heavy-duty vehicles commonly used in the commercial trucking industry. While the preferred embodiment of the present invention has been described with reference to these vehicles, it will be appreciated by those of ordinary skill in the art that modifications can be made to the structure and elements of the invention without departing from the spirit and scope of the invention as a whole and applied to all manner of on-road and off-road multi-axle and multi-wheel vehicles employing pressurized tires. The present invention could also be applied to such vehicles as farm equipment, construction equipment, monorails, trams, military equipment, and aircraft that employ pressurized tires.

While the description of the preferred embodiment of the present invention addresses its installation and operation in industry conventional Class 6, 7, and 8 vehicles using 22.5 or 24.5-inch tubeless tires mounted on either steel or aluminum wheel disc style rims, it will be appreciated by those of ordinary skill in the art that modifications can be made to the structure and elements of the invention without departing from the spirit and scope of the invention as a whole and applied to other vehicle types and wheel assemblies utilizing other tire and rim sizes and constructions. Such applications would include low profile 19 inch tires and rims, vehicles employing tag wheels, split axles, moveable trailer axles, and the like.

The preferred embodiment of the invention was described utilizing a 916.5 MHz operating frequency utilizing an on/off keying transmitter in the WMA. Alternate embodiments of the invention could be designed to operate at other appropriate frequencies in the 260-470 MHz or 902-928 MHz bands or other bands authorized by the FCC for systems of this nature and purpose. Alternate embodiments of the invention could be implemented with other data transmission protocols employing such methods as amplitude shift keying or spread spectrum communication data transmission.

The preferred embodiment of the present invention was described with a RS232 Serial Data Interface port. Alternate embodiments could employ other serial or parallel data communication port interfaces and protocols. Other data communication port implementations based on infrared or wireless technologies could also be employed in alternate embodiments of the present invention.

The preferred embodiment of the present invention was described with a RS232 Serial Data Interface port that would be primarily utilized as a test interface. Alternate embodiments could utilize the data communication port to interface the VWMSS to on-board systems such as satellite data links, cellular telephone based communication equipment or integrated vehicle health, status, and maintenance systems.

The preferred embodiment of the present invention was described as it would be applied to tractors or straight trucks operating in combination with various semi-trailers, full trailers, and dollies. However, alternate embodiments of the present invention could be applied to trailer only applications. In these applications, a modified version of the CDU and PCU would be mounted on the trailer to serve as the operator interface designed to monitor the wheel conditions only in the trailer.

Other embodiments of the invention would utilize modified forms of the CDU and PCU as a Trailer Data Concentrator and Relay Unit to facilitate hook and go trailer operations. In such applications the Trailer Data Concentrator and Relay Unit would function in such a manner so as to contain wheel identity and assignment information and the current operating conditions in the trailer wheel assemblies. The preferred embodiment of the hand-held CDU normally located in the vehicle cab would be modified to operate in conjunction with the Trailer Data Concentrator and Relay Unit.

The Trailer Data Concentrator and Relay Unit could also serve to collect other important trailer information such as refrigerated van temperatures, refrigeration system health and status data, door open/closed status, or tare weight sensor systems.

The present invention could be incorporated into an Integrated Central Tire Inflation System (CTIS). In this application, the CDU would serve as the monitoring system for the operating conditions in the vehicle wheel assemblies and provide command and control system inputs to the tire inflation apparatus.

While the invention has been described with reference to the preferred embodiment thereof, it will be appreciated by those of ordinary skill in the art that modifications can be made to the structure and elements of the invention without departing from the spirit and scope of the invention as whole.

What is claimed is:

1. A vehicle wheel monitoring system for use on a vehicle wheel comprising:
one wheel module assembly mounted on each monitored vehicle wheel to monitor wheel assembly operating parameters, each wheel module assembly transmitting a unique identifying number for each monitored vehicle wheel; and,
display means located remote from said wheel module assembly to display said wheel assembly operating parameters to an operator and receive said unique identifying number from each of said wheel module assemblies,
wherein said wheel module assembly monitors said wheel operating parameters and transmits the unique identifying number and the values of said wheel assembly operating parameters to said display and said display presents the values of said parameters to said operator and alerts said operator when said wheel operating parameters have reached inefficient or unsafe levels.

2. The system of claim 1 further comprising:
means for transmitting said unique identifying number from each of said wheel module assemblies to said display unit;
means for receiving said unique identifying number from each of said wheel module assemblies to said display unit;
means for associating said unique identifying number from said wheel module assembly with a unique vehicle wheel location; and,
means for storing each combination of unique identifying number and unique vehicle wheel location;
wherein each wheel module assembly is associated with a unique vehicle wheel location.

3. The system of claim 2 wherein said wheel module assembly further comprises:
a plurality of sensing means, each sensing means for sensing a different wheel assembly operating parameter and providing an electrical output corresponding to the value of said wheel assembly operating parameter;
identifying means for receiving a wheel probe interrogation signal and then transmitting a unique identifying number; and,
transmitting means for transmitting said electrical output corresponding to the value of said monitored wheel assembly operating parameter.

4. The system of claim 3 wherein said wheel module assembly unit further comprises:
a signal conditioning and analog to digital converting means to condition said electrical output signal from said sensing means and convert the analog signal from said sensing means to a digital signal to provide a conditioned digital electrical output signal corresponding to the value of said monitored wheel operating parameter.

5. The system of claim 4 wherein said wheel module assembly further comprises:
a processing means to receive said conditioned digital electrical output from said signal conditioning and analog to digital converting means and encode said conditioned electrical output for transmission.

6. The system of claim 5 wherein said processing means in said wheel module assembly is a microprocessor.

7. The system of claim 6 wherein said transmitting means in said wheel module assembly is a radio frequency transmitter.

8. The system of claim 7 wherein said wheel module assembly is mounted on said vehicle wheel with a spring loaded steel tensioning strap.

9. The system of claim 8 wherein one of said plurality of sensors in said wheel module assembly is a temperature sensor.

10. The system of claim 9 wherein one of said plurality of sensors in said wheel module assembly is a pressure sensor.

11. The system of claim 10 wherein one of said plurality of sensors in said wheel module assembly is a wheel module assembly battery condition sensor.

12. The system of claim 11 wherein said pressure sensor in said wheel module assembly senses absolute pressure.

13. The system of claim 12 wherein said identifying means on said wheel module assembly comprises:
a low frequency wheel interrogation receiving inductor to receive a wheel probe interrogation signal from said display means;
a wheel probe interface means to notify said processing means that a wheel probe interrogation signal has been detected; and,
a generation means for generating a normal radio frequency data link and transmitting a unique identifying number for each wheel module assembly.

14. The system of claim 13 wherein said display means further comprises:
receiving means for receiving said electrical signal corresponding to said value of said monitored parameter;
analyzing means for analyzing said electrical signal corresponding to said value of said monitored parameter;
visual display means for visually displaying the values of said electrical signal corresponding to said value of said monitored parameter to said operator;
alarm means for alerting said operator when the values of said wheel operating parameters reach a predetermined value; and,
warning means for alerting said operator when said wheel operating parameters have reached unsafe levels.

15. The system of claim 14 wherein said display means further comprises a comparing means for comparing the value of said encoded digital signal to predetermined limits for each of said monitored wheel operating parameters.

16. The system of claim 15 wherein said display means is a computer display unit said computer display unit comprising:
a polarity protector;
a storage battery with heater to provide power for said computer display unit;
a power supply to supply power to said computer display unit and to charge said storage battery;
a local ambient pressure sensor to sense the local ambient pressure;
a temperature sensor to sense the local ambient temperature;
a high radio frequency data link receiver to receive said normal radio frequency data link;
a high radio frequency antenna;
a digital signal processor to process said encoded electrical output from said wheel monitor assembly and provide an output signal;
a microprocessor to analyze said output signal from said digital signal processor;
a memory to store historical values of monitored vehicle wheel assembly parameters;
a user interface comprising:
an LED display for displaying alert icons;
an audible alarm;
an LCD display with heater;
buttons and navigational keys for navigating between menus and menu choices;
an RS 232 serial interface; and,
external electrical contacts for power supply and RS 232 interface.

17. The system of claim 16 wherein said computer display unit further comprises a wheel probe interrogation means said interrogation means comprising:
a low frequency radio transmitting means for transmitting a wheel probe interrogation signal;.
a low frequency radio antenna;
high frequency receiving means for receiving said normal radio frequency data link and unique identifying number from said wheel monitoring assembly
associating means for associating said unique identifying number with a unique wheel location;
memory means to store said unique identifying number associated with each unique wheel location; and,
visual display means for visually displaying said unique wheel location associated with said wheel module assembly.

18. The system of claim 17 further comprising:
temperature compensation means for compensating said pressure value from said pressure sensor in said wheel module assembly for the temperature value sensed by said temperature sensor in said wheel module assembly.

19. The system of claim 18 wherein said temperature compensation is according to Boyles law.

20. The system of claim 19 further comprising:
ambient pressure compensation means for compensating said pressure value from said pressure sensor in said wheel module assembly for local ambient pressure conditions.

21. The system of claim 20 further comprising:
a microprocessor in said computer display unit to accept an input, from said operator, of ideal wheel assembly pressure at a temperature of 72 degrees Fahrenheit and calculate a calculated ideal value of wheel assembly pressure which is based on said value of ideal wheel assembly pressure manually input by said operator for the temperature of 72 degrees Fahrenheit and then compensated for said local ambient pressure conditions sensed by said local ambient pressure sensor and compensated for temperature conditions sensed by said temperature sensor in said wheel module assembly; and,
visual display to display said calculated ideal value of wheel assembly pressure.

22. The system of claim 21 further comprising a power cradle unit for resting said computer display unit in, said power cradle unit comprising:
a cradle capable of holding said computer display unit;
a docking module capable of interfacing with said computer display unit, said docking module comprising:
a fused and filtered power input to said computer display unit;
a communication cable connector;
an RS 232 communication feed through to transfer the values of the monitored vehicle wheel assembly using an RS 232 signal from said computer display unit to a receiving apparatus; and,
electrical contacts located such that said contacts mate with the corresponding contacts on said computer display unit.

23. The system of claim 22 wherein said warning means on said display unit provides warning to said operator when the value of the compensated pressure signal is 20 pounds per square inch higher or lower than said calculated ideal value of wheel assembly pressure.

24. The system of claim 23 wherein said warning means on said display unit further comprises:
a warning to said operator when the value of the temperature signal is greater than operator selected limits.

25. The system of claim 24 wherein said warning means on said display unit further comprises:
a warning to said operator when the measured differential pressure value between two vehicle wheel assemblies in a set of dual wheels exceeds 5 pounds per square inch.

26. The system of claim 25 wherein said warning means on said display unit further comprises:
a blow out warning limit when the measured pressure in any one wheel assembly falls below 45 pounds per square inch gauge after the wheel assembly has once been inflated to above 30 pounds per square inch gauge.

27. The system of claim 26 wherein said alarm means further comprises:
a first warning limit to alert said operator when said actual compensated pressure value is less than said ideal pressure value, said first warning limit being set by said operator at 5, 10 or 15 pounds per square inch above and below the ideal pressure value in accordance with the preference of said operator.

28. The system of claim 27 wherein said alarm means further comprises;
an audible alarm; and,
a visual alarm.

29. The system of claim 28 further comprising:
an operational system failure warning to alert said operator of any system failures.

30. The system of claim 29 further comprising:
a missing wheel module assembly warning to alert said operator when said display unit detects that a wheel module assembly is not sending a signal to the display unit.

31. The system of claim 30 wherein said computer display unit is removably mounted in said power cradle unit and may be take to the location of each monitored vehicle wheel assembly.

32. The system of claim 31 further comprising:
a power cable assembly to supply power to said power cradle unit.

33. The system of claim 32 wherein said power supplied by said power cable assembly is switched.

34. The system of claim 33 wherein said power supplied by said power cable assembly is not switched.

35. The system of claim 34 wherein said transmitting means on said wheel module assembly is connected to the valve stem of said vehicle wheel so that said wheel module operating parameters are transmitted through said valve stem.

36. The system of claim 35 wherein said receiving means on said display unit is removably connected to said valve stem of said vehicle wheel so that said wheel module operating parameters are received through said valve stem.

37. The system of claim 36 further comprising:
a centrifugal switch in each of said wheel module assemblies said centrifugal switch disengaging said low frequency wheel interrogation receiving inductor when said vehicle wheel rotates and engaging said low frequency wheel interrogation receiving inductor when said vehicle wheel is not rotating.

38. A method of monitoring wheel condition for use on a vehicle wheel assembly consisting of the steps of:
(a) sensing a wheel operating pressure for each monitored wheel assembly;
(b) sensing wheel operating temperature for each monitored wheel assembly;
(c) transmitting the value wheel operating pressure for each monitored wheel to a remote location;
(d) transmitting the value wheel operating temperature for each monitored wheel to a remote location;
(e) receiving a wheel probe interrogation signal;
(f) transmitting a unique identifying number to a remote location; and,
(g) displaying said value of said monitored parameters for each vehicle wheel assembly, remote from said vehicle wheel consisting of the following steps;
(h) receiving said value of said monitored wheel assembly operating pressure from each of said wheel assemblies;
(i) receiving said value of said monitored wheel assembly operating temperature from each of said wheel assemblies;
(j) receiving said value of unique identifying number from each of said wheel assemblies;
(k) assigning each of said unique wheel identifying numbers a unique vehicle location;
(l) analyzing said values of wheel operating pressure and wheel operating temperature to determine if said values are within predetermined limits;
(m) displaying said values of said wheel operating pressure and wheel operating temperature visually for an operator
(n) sounding an alarm when said values of said wheel operating parameters reach predetermined values; and,
(o) warning said operator when said values of said wheel operating parameters reach unsafe levels;
wherein said wheel module assembly monitors said wheel operating parameters and transmits the values of said parameters to said display and said display presents the values of said parameters to said operator and alerts said operator when said wheel operating parameters have reached unsafe levels.

39. The method of claim 36 further comprising the steps of;
(p) measuring local ambient pressure;
(q) compensating said value of wheel operating pressure for local ambient pressure;
(r) compensating said value of wheel operating pressure for wheel temperature.

40. A method of monitoring wheel condition for use on a vehicle wheel assembly consisting of the steps of:
(s) measuring a plurality of wheel assembly operating parameters;
(t) transmitting the value of each wheel assembly operating parameter to a remote location
(u) transmitting a unique identifying number for each wheel assembly to a remote location;
(v) receiving the value of each wheel assembly operating parameters from said wheel assembly;
(w) receiving the unique identifying number for each wheel assembly from said wheel assembly;
(x) associating each unique wheel assembly number with a unique vehicle wheel location; and,
(y) displaying said values of each wheel assembly operating parameter to an operator;
wherein said wheel module assembly monitors said wheel operating parameters and transmits the values of said parameters to said display and said display presents the values of said parameters to said operator and alerts said operator when said wheel operating parameters have reached unsafe levels.

41. The method of claim 39 further comprising the steps of:
(z) compensating said wheel assembly operating parameters for operating temperature and local barometric pressure.
